(19) United States
(12) Patent Application Publication
(10) Pub. No.: US 2010/0093535 A1
(43) Pub. Date: Apr. 15, 2010

(54) PLANTING MIX COMPOSITIONS AND METHODS

(75) Inventors: Bill L. Rose, Hubbard, OR (US); Milan Savich, Beaverton, OR (US)

Correspondence Address: KLARQUIST SPARKMAN, LLP, 121 SW SALMON STREET, SUITE 1600, PORTLAND, OR, 97204, US

(73) Assignees: Rose Agri-Seed, Inc.; Absorbent Technologies, Inc.

(21) Appl. No.: 12/611,832

(22) Filed: Nov. 3, 2009

Related U.S. Application Data
(63) Continuation-in-part of application No. 12/056,156, filed on Mar. 26, 2008.
(60) Provisional application No. 60/920,352, filed on Mar. 26, 2007.

(51) Int. Cl. A01N 25/32; A01N 25/26

(52) U.S. Cl. 504/100; 504/103

(57) ABSTRACT

This application provides seed coating compositions and methods of making such compositions. In particular examples, such compositions include a binder and an activated charcoal-containing composition (which can further include diatomaceous earth and other components), such as seeds at least partially coated with a binder and an activated charcoal-containing composition adhered to the seed by the binder. Seeds at least partially coated with a binder and an activated charcoal-containing composition adhered to the seeds by the binder, and methods of using such seed are also provided. Also provided are seeds that have adhered thereto binder and an activated charcoal-containing composition.

### CROSS REFERENCE TO RELATED APPLICATIONS

This application is a continuation-in-part of U.S. Ser. No. 12/056,156, filed Mar. 26, 2008, which claims priority to U.S. Provisional Application No. 60/920,352 filed Mar. 26, 2007, both herein incorporated by reference.

### FIELD

This application relates to planting mix compositions and methods of preparing such compositions that prepare seed for planting, such as compositions that include seeds and bulking agents.

### BACKGROUND

Currently, most growers plant seed in rows and then follow up with 20-30 pounds per acre of activated charcoal, applied over the rows of planted seed in a band. The field is then sprayed at 1-3 pounds per acre of herbicide, such as one that is neutralized by activated charcoal, for example Karmex (Diuron). Atrazine, and others. Herbicide is applied to kill the weeds. However, any weed seed located in the row of crop seed, which is protected by the charcoal band, will still grow. Therefore, methods are needed which will achieve weed kill while protecting the seedlings from herbicide.

### SUMMARY

The inventors have found that coating seeds with a binder (such as lignosulfonate) along with a coating agent (such as a coating agent that includes activated charcoal and in some examples also diatomaceous earth, super-absorbent polymer (SAP) particles, or combinations thereof), provides an unexpectedly superior environment for protecting seeds from herbicides that are neutralized by activated charcoal, and thus allows for superior weed kill where the coated seeds are planted. For example, use of the disclosed coated seeds in combination with application of a herbicide that is neutralized by activated charcoal (but without application of activated charcoal to the planted crop), results in a crop or other planted area that is virtually weed-free (for example less than 0.01% weeds, less than 0.05%, weeds, less than 0.5% weeds, or less than 0.1% weeds).

This disclosure provides methods and compositions for coating seeds, which achieves significant weed kill while protecting the seedlings from herbicide. This results in the production of a crop which is substantially free of weeds, while eliminating the competition of weeds in the row of seedlings (such as a grass or vegetable crop). The methods provided herein can replace the present charcoal banding technique now used. An ordinary grain drill, equipment most growers already have, can plant the coated seed and achieve a clean stand of crop (e.g., grass or vegetable) essentially free of weeds.

Seed-coating compositions are provided. In one example the composition includes a binding material that provides an environment to allow other coating materials to adhere to the seed. In one example, the binding material is lignosulfonate. The other materials adhered to the seed can include an activated charcoal-containing composition. Such charcoal-containing compositions can further include other agents, such as diatomaceous earth, SAP particles, growth promoting agents, and combinations thereof. Seeds coated with such materials can be referred to as “coated seeds;” however such a term does not require 100% coating of the seed surface by either the binder or the activated charcoal-containing composition. The composition can further include seeds at least partially coated with a binder and an activated charcoal-containing composition (which can further include other agents, such as diatomaceous earth) adhered to the seeds by the binder. In a specific example, a composition is provided that includes seeds at least partially coated with a binder (e.g., lignosulfonate) and activated charcoal and diatomaceous earth adhered to the seeds by the binder

Also provided by the present disclosure are methods of making seeds that are coated with an activated charcoal-containing composition. In particular examples, the method includes coating seeds at least partially with a binder and then adhering a coating composition comprising activated charcoal to the binder-coated seed. In some examples, multiple rounds of alternating between applying the binder and applying the activated charcoal-containing composition are performed, thus producing a seed with multiple layers of binder and the activated charcoal-containing composition. In particular examples, the method further includes planting the coated seed, thereby permitting germination of the seed. For example, herbicide can be further applied to the planted seeds, thus eliminating the need to apply activated charcoal over the planted seeds prior to applying the herbicide. The activated charcoal used to coat the seeds protects the seeds from the herbicide, and allows production of a crop that is essentially weed-free, without the need to apply activated charcoal to the crop prior to applying herbicide to the planted crop seeds. In particular examples, the herbicide is one that is neutralized by activated charcoal.

The disclosure also provides seed (such as a crop seed, for example a grass or vegetable crop) that is at least partially coated with a binder and at least partially coated with a coating composition that includes activated charcoal (and in some examples also diatomaceous earth, SAP particles, or combinations thereof) adhered to the seed by the binder.

The foregoing and other objects and features of the disclosure will become more apparent from the following detailed description, which proceeds with reference to the accompanying figures.

### BRIEF DESCRIPTION OF THE DRAWINGS

FIG. 1 is a digital image of test plots seeded with an equal amount of (left) uncoated seashore paspalum seed or with (right) a coated seashore paspalum seed/coated filbert shell fragment mixture.

FIG. 2 is a bar graph demonstrating that using a mixture containing coated seeds and coated filbert shell fragments provides the same 100% soil coverage with 50% less seeds.

FIG. 3 is a digital image of test plots seeded with an equal amount of ryegrass seed coated with charcoal and lignosulfonate and then treated (or not) with herbicide (none, 1 pounds/acre or 4 pounds/acre Karmex).

FIG. 4 is a digital image of test plots seeded with an equal amount of ryegrass seed coated with charcoal, diatomaceous earth and lignosulfonate and then treated with herbicide (2-4 pounds/acre Karmex).

### DETAILED DESCRIPTION

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a bulking agent” includes single or plural bulking agents and encompasses the phrase “comprising at least one bulking agent.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. For example, the phrase “activated charcoal or coir” means including activated charcoal, including coir, or including both activated charcoal and coir.

Unless explained otherwise, all technical and scientific terms used herein have the same meaning as commonly understood by one of ordinary skill in the art to which this disclosure belongs.

Binder: A material used to adhere one agent to another, for example adhere a composition containing activated charcoal (and optionally further including diatomaceous earth and/or SAP-particles) to seed. In particular examples, a binder provides a moist environment to which a seed-coating composition can adhere. Particular non-limiting examples of binders that can be used are lignosulfonate and Elmer's glue. Lignosulfonates, or sulfonated lignin, (CAS number 8062-15-5) are water-soluble anionic polyelectrolyte polymers: they are byproducts from the production of wood pulp using sulfite pulping. In one example, the binder is not polyvinyl alcohol.

Bulking agent: Materials that can be added to a population of seed to increase the volume of the seed population. In some examples, such agents improve the physical handling properties of the seed, for example water retention, flowability, water infiltration, drainage, aeration and structure. In some particular examples, such agents are not water soluble. In some examples, bulking agents are in a chunk, crushed, object, particle or granular form. Specific non-limiting examples include nutshells (such as nutshell fragments), coir (from coconuts), vermiculite, perlite, rubber particles (such as tire pieces), and sand, as well as admixtures and combinations thereof. In a specific example, a bulking agent includes or consists of nutshell fragments, such as filbert shell fragments. In a specific example, a bulking agent includes or consists of coir.

Coir: The coarse fiber found between the husk and the outer shell of a coconut. Can be used as a bulking agent to absorb moisture.

Coating: A material applied to the outer surface of an agent, such as a seed surface. In particular examples, includes applying a material to the outer surface of a seed or bulking agent (such as a nutshell fragment or coir). However, coating does not require 100% coverage of the surface of the agent; partial coverage can be sufficient. For example, coating can in some examples result in coverage of at least 1% of the surface by the material, such as at least 10%, at least 20%, at least 50%, at least 80%, at least 95%, or at least 99% coverage of the surface of the desired surface (such as a seed or nutshell fragment).

A coating material can be directly applied to the agent (for example by incubating the coating material with the agent to be coated), or indirectly applied (for example by adhering a first material (e.g., a binder) to the surface of the agent to be coated that permits attachment of a second material, and then adhering the second material to the agent already coated with the first material).

In one particular example, coating does not result in significant or any penetration of the covering or coating into the agent, such as penetration of a seed, shell, or bulking agent. In some examples, the thickness of a coating applied is at least 0.01 mm, for example at least 0.05 mm, such as about 0.01 mm to 0.1 mm. In particular examples, coating an agent alters the properties of the agent, for example to increase the ability of the agent to retain or absorb moisture.

Germination: The sprouting of a plant seed into a seedling, for example from a grass seed into a plant.

Germination rate: The proportion of seeds in a given batch or lot of seed that germinate. For example, a germination rate of 50% indicates that about 50% of the seeds in the batch will germinate when planted under conditions that permit germination.

Nutshell: The shell or hard external covering which encloses the kernel of a nut. Nutshells can be obtained from any desired nut, such as filberts (hazelnuts), pine nuts, pistachios, pecans, walnuts, Brazil nuts, coconuts and almonds. Nutshells are often a waste product of nut manufacturers. Nutshell fragments can be obtained using routine methods, such as by manipulation of the shell into smaller particles, fragments, or granules. For example, nutshells can be ground or subjected to other physical manipulation or can be treated chemically, to generate fragments of the nutshell or shell product (e.g., coir from coconuts). A substantially uniform population of nutshell fragments can be obtained, for example by passing the fragments through a mesh screen (such as those used in cleaning the desired seed).

Seed: The ripened ovule of gymnosperm or angiosperm plants, and includes the embryo and its proper coats and can also include the seed coat (an outer protective covering). Seeds are very diverse in size and shape. The disclosure is not limited to particular plant seeds, and can include for example grass seeds, flower seeds, tree seeds, and vegetable seeds (such as lettuce, beets, carrots, soy beans, corn, onions and the like). In a specific example, the seed is a grass seed, such as a seashore paspalum grass seed, ryegrass seed, fescue seed, or bentgrass seed. In one example, the seed is a wheat seed.

Super-absorbent polymer (SAP): Materials that imbibe or absorb large quantities of aqueous fluid (such as water), for example at least 10 times their own weight, and that retain the imbibed or absorb aqueous fluid under moderate pressure. Generally, SAPs are water-insoluble polymers which swell or gel in aqueous fluids but do not dissolve in the fluids. Some SAPs can absorb up to 1000 times their weight in aqueous fluid. These polymers are typically lightly cross-linked polymers, which contain a multiplicity of acid functional groups such as carboxylic acid and carboxamide acid groups.

Exemplary SAPs include totally synthetic copolymers (such as those made by copolymerizing acrylic acid and acrylamaide in the presence of a coupling agent), starch graft copolymers (such as those that use a natural polymer, such as starch to form an SAP product including a starch graft copolymer), and starch-based SAPs (such as those described in US Patent Application No. 2005/0159315, herein incorporated by reference as to the composition of the starch-based SAP, for example Zeba® available from Absorbent Technologies, Inc., Oregon).

A SAP-containing composition is a composition that includes SAPs, such as SAP-particles. Such a composition can be adhered to seed or bulking agents, for example by first at least partially coating the seed or bulking agent with a binder to which the SAP-containing composition can bind. In particular examples, the SAP-containing composition includes other agents, such as activated charcoal, filler (for example calcium carbonate, clay, gypsum, bentonite, dry diatomaceous earth, coir, or combinations or admixtures thereof), growth-promoting agents (for example fertilizers, pesticides, growth hormones, nutrients, or combinations or admixtures thereof), coloring agents, or combinations thereof.

### Seed Coating Compositions

The present disclosure provides compositions that can be used to coat seeds, such as crop seeds. In particular examples, such compositions can be added to bulk seed to protect the seeds from herbicide (such as herbicide that is neutralized by activated charcoal). In some examples, such coated seeds have a greater germination rate following application of an herbicide without application of activated charcoal over the planted seeds, relative to the same seed that is uncoated. In some examples, germination of the coated seed following application of an herbicide without application of activated charcoal over the planted seeds is increased by at least 10%, such as at least 20%, at least 40%, at least 50%, at least 75%, at least 80%, at least 90%, at least 95%, or at least 100%, relative to germination of uncoated seed of the same type following application of an herbicide without application of activated charcoal over the planted uncoated seeds. In some examples, increased germination is evidenced by one or more of increased germination rate, earlier seed germination, increased crop growth, or increased crop production. In some examples, the disclosed coated seeds can tolerate greater concentrations of herbicide than corresponding uncoated seeds (in the absence of activated charcoal applied to the planted row), for example at least 4 pounds of herbicide per acre, at least 5 pounds, or at least 6 pounds per acre.

In particular examples, the seed-coating composition includes activated charcoal (for example an activated charcoal-containing composition) and a binder, such as lignosulfonate, for example at a ratio of about 1:1 by weight. In specific examples, the binder is not polyvinyl alcohol. For example the seed-coating composition can include activated charcoal and lignosulfonate, and in some examples further includes diatomaceous earth, for example at a ratio of about 1:1:1 by weight. In one example, the activated charcoal and the diatomaceous earth are present in the composition at a ratio of 1:1 by weight. In specific examples, the seed-coating composition includes activated charcoal, lignosulfonate, diatomaceous earth and super-absorbent polymer (SAP) particles. In particular examples, the SAP comprises about 0.5 to 5% weight of the coating composition (or of the seed to be coated).

The composition can include the seeds coated at least partially with the binder (e.g., lignosulfonate) and an activated charcoal-containing composition adhered to the seeds by the binder. For example, provided are seeds coated at least partially with lignosulfonate, and with activated charcoal and diatomaceous earth adhered to the seeds by the lignosulfonate. In particular examples, the seed to lignosulfonate/activated charcoal-containing composition (such as a composition that includes charcoal and diatomaceous earth) ratio is at least 1:2, at least 1:4, at least 1:5, at least 1:6, or at least 1:10, such as 1:4, 1:5, 1:6, 1:7, 1:8, 1:9, 1:10 or 1:20. Such seeds in some examples also include SAP particles (which may be applied separately from the charcoal-containing composition). In some examples, the weight of the SAP particles is considered part of the lignosulfonate/activated charcoal-containing composition part of the ratio. Thus, if the seeds are coated with lignosulfonate/activated charcoal-containing composition/SAP particles, the seed to lignosulfonate/activated charcoal-containing composition/SAP particles ratio can be at least 1:2, at least 1:4, at least 1:5, at least 1:6, or at least 1:10, such as 1:4, 1:5, 1:6, 1:7, 1:8, 1:9, 1:10 or 1:20.

The seed coating composition adhered to the seed by the binder can include other agents. In one example, the seed coating composition includes other bulking agents or fillers, such as one or more of calcium carbonate, clay, gypsum, bentonite, coir, and dry diatomaceous earth (or admixtures thereof). The bulking agents can be present in an activated charcoal containing composition that is applied to seed following at least partial coating with the binder. In particular examples, such agents make up at least 85% of the composition by weight, such as at least 90% of the composition by weight, for example about 90 to 99%, 95 to 99%, 95 to 98% or 95 to 97% by weight of the composition.

The activated charcoal-containing composition that includes activated charcoal and optionally additional bulking agents such as diatomaceous earth, can include other agents. For example, the composition can include one or more growth-promoting additives, such as fertilizers, pesticides (such as a fungicide), growth hormones, soil-based nutrients, or combinations thereof, as well as colorants.

In one example, the disclosed compositions also include seeds, such as seeds at least partially coated with a binder by which an activated charcoal-containing composition are adhered to the seed (herein referred to as “coated seed”). In a particular example, the amount of activated charcoal-containing composition added to the seed is at least a 2:1 ratio by weight of charcoal to seed (such as a ratio of about 3:1, 4:1, 5:1, 6:1, or 10:1).

In particular examples, the coated seeds are about 0.1 mm to 10 mm in diameter, for example 0.5 mm to 7 mm in diameter, or 0.5 mm to 2 mm in diameter. In particular examples, the coated seeds are about 0.5 mm wide and 2 mm long or about 3.5 mm wide and 7 mm long. In a specific example, the resultant coated seed is similar in size to a wheat kernel, such as about 5 mm long by 2.5 mm deep, such that the resultant coated seed can be planted using machinery used to plant wheat, for example at a rate of about 100 lbs coated seeds per acre. To obtain such uniformity, coated seeds can be placed through a same mesh sieve, and the desired sized seeds collected.

Lignosulfonate is a water-soluble anionic polyelectrolyte polymer, which is a byproduct from the production of wood pulp using sulfite pulping. When using polyvinyl alcohol as the binder, the inventors observed that the water solubility is unsatisfactory, and results in slow germination. Lignosulfonate is less viscous and breaks down quicker, but still achieves acceptable durability. The use of lignosulfonate in the coating process creates a durable charcoal casing, which dissolves within 48 hours of planting. This creates protection from herbicides and timely solubility for germination.

Diatomaceous earth is a naturally occurring, soft, chalk-like sedimentary rock that is easily crumbled into a fine white to off-white powder, with a particle size extending from less than 1 to over 100 microns. Diatomaceous earth builds bulk with a light dense material. In addition to building bulk diatoms add value by increasing absorption. When adding diatomaceous earth to the formula, it produces a nice pellet which breaks down easily during the germination process.

SAPs are agents that can absorb aqueous fluids and retain the fluid under moderate pressure, such as water-insoluble hydrogel-forming polymers which swell aqueous fluids but do not dissolve in the fluids. SAPs are known in the art, and the disclosure is not limited to particular SAPs. Examples of SAPs that can be used include but are not limited to cross-linked polyacrylamide polymers (such as Broadleaf P4, SANWET IM-300 and IM-1000, AQUASTORE, AGRIGEL, and GROWSOAK 400, seaweed based products (such as ALGINURE), starch graft copolymers, and starch-based SAPs. In a specific example, the SAP is a starch-based SAP, such as those described in US Application No. 2005/0159315 (herein incorporated by reference as to the starch-based SAP compositions), for example Zeba® (Absorbent Technologies, Inc., Oregon). Zeba® is a unique superabsorbent polymer based on natural cornstarch, making it biodegradable, nontoxic and odorless. As a starch-based polymer, Zeba® is made up of glucose molecules, which are linked together chemically to become a water-insoluble, net-like matrix in the form of a hydrogel that holds and releases water for use by plants as needed. Zeba® can be added to coating compositions to ensure the seedling has water readily available during the germination process. The concentration of SAP to be used in the seed coating composition can be determined by those skilled in the art. In one example, the seed coating composition adhered to seeds can include about 0.5% to 5%, SAP or 1 to 5% SAP, such as 2 to 5%, 2.5 to 5%, or 3 to 5% SAP by weight of the seed.

The disclosure is not limited to particular seeds. Any plant seed can be at least partially coated with a binder to which an activated charcoal-containing composition is adhered. Exemplary seeds include those that can germinate into flowers, trees, grasses (such as fescue (for example fine and tall fescue), seashore paspalum (such as the seashore paspalum ‘Sea Spray’ variety, for example, seashore paspalum ‘Sea Spray’ seed deposited at American Type Culture Collection (ATCC) under Accession No. PTA-682), ryegrass, forage grass, and bluegrass), and those used to plant crops (such as soy, beans, cotton, tobacco, tomatoes, corn, lettuce, beets, melon, rye, and wheat) or any seed that can benefit from this method. In a specific example the seed is a grass seed.

Various ratios of the seed to coating agents (such as activated charcoal, diatomaceous earth and lignosulfonate) can be present in the composition. In some examples, the coated seeds and coating agents are present in the composition at a ratio of about 20% seed to about 80% coating agents by weight (that is a ratio of about 1 to 6). In other examples, the coated seeds and coating agents are present in the composition at a ratio of about 2 to 1, 3 to 1, 4 to 1, 5 to 1, 6 to 1, 10 to 1, 15 to 1, of coated seed to coating agents.

### Methods of Making Coated Seeds

Methods of producing coated seeds, such as seeds coated with an activated charcoal-containing composition (referred to herein as charcoal-coated seeds), are provided. In particular examples, the resulting coated seeds have increased germination relative to uncoated seed when planted (e.g., covered with earth or organic material) in a crop to which herbicide but not activated charcoal has been applied. Indications of increased germination include, but are not limited to, earlier seed germination or blooming, decreased irrigation requirements, increased germination, increased crop growth, increased crop production or yield, increased plant size, increased germination rate, or combinations thereof. For example, increased germination can be relative to seed not coated with a binder and an activated charcoal-containing composition, such as an increase of at least 20%, at least 50%, at least 75%, or at least 95%.

In particular examples, the method includes at least partially coating seed and one or more bulking agents with a binder (such as lignosulfonate), thereby generating binder-coated seed. The binder-coated seed is then exposed to a composition that includes activated charcoal under conditions that permit the activated charcoal-containing composition to bind to the binder-coated seeds, thereby generating charcoal-coated seeds. As discussed above, activated charcoal-containing compositions can include other elements, such as bulking agents (e.g., diatomaceous earth), SAPs (discussed above), growth promoting agents, or combinations thereof. In some examples, the seed is exposed to multiple rounds of coating, for example alternating between the binder and the activated charcoal-containing composition (e.g., first applying the binder, then the activated charcoal-containing composition; see Tables in Example 7), such that the seed is even more completely coated and in some examples increased in size (e.g., bulked). In particular examples, SAP particles are adhered to the binder-coated seeds or the charcoal-coated seeds, for example as a last step in the coating process. As discussed above, the disclosure is not limited to use of particular SAPs.

In particular examples, the method can further include planting the charcoal-coated seed, thereby resulting in germination of the planted seed and in some examples assists in accurate planting of the seed. The method can also further include applying herbicide to the planted seeds (e.g., after the seeds have been planted and covered with dirt or organic material), for example at a rate of 0.1 to 3 pounds per acre, such as 0.5 to 2 pounds per acre. Herbicides are routinely applied to crops to kill weeds and undesired grasses present in crop fields. However, the method does not include placing charcoal over the planted seed row prior to applying the herbicide. For example, current methods in crop planting include planting the seeds, followed by covering the planted seed row with 20 to 30 pounds per acre of activated charcoal, then applying at least pound per acre of herbicide (such as at least 3, at least 4, at least 5, or at least 6 pounds per acre, for example, 1, 2, 3, 3.5 4, 4.5, 5, 5.5, 6, 7, 8, 9 or 10 pounds per acre of herbicide) to the entire field of planted crops. The applied activated charcoal neutralizes the herbicide, thus protecting the seeds from the herbicide, but allowing the areas outside of the planted seed row to be exposed to the herbicide and kill the weeds. Numerous herbicides are neutralized by activated charcoal, and can be used in the disclosed methods. Examples include but are not limited to Karmex (Diuron), Kerb®, and simazane (2-chloro-4,6-bis(ethylamino)-s-triazine). Others are well-known in the art.

In particular examples, the method can further include placing the resulting coated seed through a mesh sieve, resulting in a population of coated seeds that are very similar in size. In a particular example, the coated seed and coated bulking agent is approximately the same size as a wheat kernel, for example about 5 mm long and 1.5 m in depth. Other exemplary sizes are provided above.

In very specific examples, the method includes coating grass seed (such as a ryegrass seed blend) at least partially with lignosulfonate, and adhering a composition that includes activated charcoal and diatomatious earth to the lignosulfonate-coated seeds. In a specific example the weight ratio of seed:lignosulfonate/activated charcoal/diatomatious earth is about 1:6.

As discussed above, the disclosure is not limited to use of particular seeds. Seeds from any plant can be used. Exemplary seeds are described above. In addition, the seed can include a mixture of different types of seeds, such as a mixture of different grass seeds. In a specific example, the seed is a grass seed, such as a ryegrass seed.

### Coating Seeds

Methods of coating a seed are known in the art. For example, commercially available coating equipment is capable of producing a coating on the seed. Exemplary types of coating equipment are a ribbon/paddle blender, an inclined rotary pan-type, and a rotostat mixing chamber.

In particular examples, an adhesive or binder (such as lignosulfonate) is first applied to the seeds under conditions that permit at least partial coating of the seeds with the binder. This will allow an activated charcoal-containing composition (e.g., that may further include diatomaceous earth and other ingredients as discussed herein), to adhere to the seeds, for example by creating a favorable moist surface for the activated charcoal-containing composition to adhere. For example, raw seed can be exposed to the binder for a time sufficient to obtain at least partial coverage (for example at least 10%, at least 20%, at least 50%, at least 75%, at least 90%, or at least 99% coverage) on each seed. Typically, exposure to the binder occurs at room temperature (such as about 20-30° C.). In particular examples, the raw seed is exposed to the binder for at least 1.5 minutes, at least 2 minutes, at least 4 minutes, or at least 5 minutes, no more than 20 minutes, no more than 10 minutes, such as 3 to 10 minutes, 5 to 10 minutes, or 5 to 8 minutes. Other exemplary timing protocols are provided in Example 7.

In some examples, the binder material is inert to the seed, for example does not significantly impair seed germination. In particular examples, the binder is lignosulfonate. In other examples, the binder is not polyvinyl alcohol (PVOH) or a similar material within the same class used in the seed coating industry (such as polyvinyl acetate and others within this category).

The amount of binder solution applied to the seeds can affect the quality of the coating: too much binder will result in lumps, while inadequate amounts of binder will cause the coating to dust off, offer low durability and low buildup. Ideally, the adhesive will not impair seed germination, will give seeds or bulking agents a durable coating when dry, and will be readily soluble in water so that the coating will not stick on the seed or bulking agents once wet.

In particular examples, the amount of binder added is about equal in weight of the total seed to be coated, such as about 80% to 120% of the weight of the seed to be coated. In some examples, the larger the seed or bulking agent particle to be treated, the higher the percentage of binder used. Those skilled in the art appreciate how to determine optimal amounts of binder and moisture levels to use.

The seeds, which in some examples are at least partially coated with binder, are exposed to an activated charcoal-containing composition under conditions that permit activated charcoal (and in some examples other elements, such as diatomaceous earth, SAP particles, growth promoting agents, etc.) to adhere to the seed. In particular examples, the activated charcoal-containing composition includes finely ground mineral material, which will adhere to the moist surface of the seed, thereby coating the seed. In particular examples, this mineral content does not substantially dissolve in water and keeps the moist seeds from sticking to each other. Among the exemplary particulate solids are calcium carbonate, clay, gypsum, bentonite, and dry diatomaceous earth.

If desired, other additives can be included in the activated charcoal-containing composition to be applied to the seeds. Particular examples include growth-promoting agents, such as agents that increase the survival rate and health of the young plants. Examples include nutrients, fertilizers, fungicides, herbicides, pesticides, trace elements, growth hormones or combinations thereof. Nutrients routinely used in commercial grass seed coatings include but are not limited to N, P, K, S, Fe and Zn. In acidic soils, lime coatings for seeds can be beneficial to seedling performance. The conventional seed coating percentage is about 33% (such as a seed to fill ratio of 1 to 0.5) for small-seeded legume seeds to about 50% (such as a seed to filler ratio of 1:1) for grass seeds. In particular examples, the amount of activated charcoal-containing composition exposed to the seeds is an amount at least two-times the weight of the seeds (for example, if the seeds weigh 100 lbs, 200 lbs of activated charcoal-containing composition is used to adhere the activated charcoal-containing composition to the seeds). In other particular examples, the amount of activated charcoal-containing composition exposed to the seeds is an amount at least six-times the weight of the seeds (for example, if the seeds weigh 100 lbs, 600 lbs of activated charcoal-containing composition is used to adhere the activated charcoal-containing composition to the seeds).

In a particular example, the activated charcoal-containing composition is adhered to seeds separately from a SAP containing-composition. For example, the activated charcoal-containing composition can be applied first, following an application of SAP particles.

The seeds (which in some examples are at least partially-coated with a binder) are mixed with an activated charcoal-containing composition to adhere the activated charcoal-containing composition to the seed. Methods that permit such binding are known in the art. For example, the seed can be tumbled (for example in a drum), and the activated charcoal-containing composition slowly added, for example by applying the activated charcoal-containing composition upon the seeds (such as by spraying). The equipment can be run until the seed is at least partially coated (such as at least 25%, at least 50%, at least 80%, at least 90%, or 100% coated), for example for at least 5 minutes, at least 10 minutes, such as 10 to 12 minutes. Similar methods can be used to adhere SAP particles, for example if SAPs and activated charcoal or coir are adhered in two separate stages. Exemplary protocols are provided in Example 7.

If desired, the seed can be colored with an agent (such as a pigment or dye) to identify the coated seed or coated bulking agent. Ideally, the coloring agent will not significantly inhibit germination or other desirable biological activity of the seed. This colorant can be incorporated into an activated charcoal-containing composition, or into the binder composition. Alternatively, the colorant can be applied after the seed is coated. An exemplary colorant is aqua-blue. In some examples, when activated charcoal is adhered to the seeds, no additional colorant is added.

The activated charcoal-containing composition on the seed can be compacted onto the seed using methods known in the art. Such compacting can be performed to reduce the amount of coating ‘flaking off, for example during transit or handling of the seed. For example, the coated seed can be fed into a mechanism, such as an inclined drum, to compact the coating. In one example, the coated seeds are rolled on themselves (for example in a steel drum), thereby compacting the coating.

After the seeds are at least partially coated with binder, have the activated charcoal-containing composition adhered, and are compacted, the coated seed can be dried. For example, drying can significantly reduce imbibing of moisture by the seed, thereby reducing unwanted pre-germination. In addition, drying can rapidly draw-off moisture without using excessive heat (which can kill the seed). Methods of drying are known in the art, for example using a large fluid bed dryer or forced hot air system. Depending on the type of drying equipment, temperatures for drying the coated seed can be as high as 180° F. for a short time, such as 5 minutes or less, such as 1 to 5 minutes or 1 to 3 minutes.

After drying, the coated seed can be screened for size, and can be bagged. In particular examples, the coated seed can be screened using mesh screens. The desired-sized particles can be selected. At this point the weight and size of the seed has increased, but the finished coated seed remains principally the same shape as it was prior to coating.

In particular examples, the total time to coat and process a batch of seed takes about 20 to 25 minutes. Specific examples are provided in Example 7.

### Example 1

### Generation of Coated Seeds

This example describes methods used to adhere Zeba® superabsorbent polymer particles to seashore paspalum ‘Sea Spray’ grass seeds. One skilled in the art will recognize that similar methods can be used to generate coated seeds from other grasses or other plants.

Zeba® was adhered to the seed via a binder to increase the amount of moisture absorbed into the seed coating layer. With Zeba®, cracking will occur in 2 or 3 ‘block’ portions, increasing the opportunities for light and moisture penetration and thereby providing greater chance of germination. Only a relatively small amount of Zeba® is needed to provide these benefits; Zeba® was applied at a rate of 2½% to 3% of the weight of the seed.

An adhesive or binder was used to adhere the Zeba® coating to the seed, by creating a favorable moist surface for the SAP-containing composition (Zeba® powder and filler material). Because Zeba® is a superabsorbent product and absorbs water very readily, polyvinyl alcohol (PVOH) was used as the binder (such as Celvol® (Celanese Corporation) and BF17 (Kel Chemical)). A rate of 5 to 6 pounds of powder PVOH to 100 pounds of grass seed was used to provide a sufficiently moist surface for the SAP-containing composition to adhere. The raw seed was exposed to the PVOH binder for 5 to 8 minutes at room temperature to obtain thorough coverage on each seed piece using blending.

The moist seeds coated with PVOH were contacted with the SAP-containing composition, which included finely ground mineral filler material (plus other additives as desired, for example calcium carbonate, clay, gypsum, bentonite, and dry diatomaceous earth) and Zeba®. The mineral material does not substantially dissolve in water and was used to keep the moist seeds from sticking to each other.

After at least partially coating the seed with PVOH, the SAP-containing composition (finely ground filler base-mineral and additives, including Zeba®) was exposed to the seed. While the seeds were being tumbled in a drum, the SAP-containing composition was applied to the seeds. The amount of finely ground mineral material and Zeba® needed were measured beforehand, and mixed together into a single SAP-containing composition. This ensured that the seeds did not stick to each other and the coating was more consistent. Approximately 100 lb seed was contacted with approximately 100 lb of the SAP-containing composition. Coir can be added to improve the speed of water absorption when germination is desired. The seeds were tumbled with the SAP-containing composition for about 10 to 12 minutes. This resulted in a coated seed (though 100% coverage by the SAP-containing composition is not required).

The surface of the coated seed can be colored with an agent such as a pigment or dye to identify the coated seed. In a specific example, the colored agent was aqua-blue.

The seed was fed into an inclined drum to compact the seed coating and reduce the amount of filler material ‘flaking off’ later in transit or as the seed is handled.

The coated seeds were then immediately dried before too much moisture was imbibed by the seed, causing unwanted pre-germination. A large fluid bed dryer or forced hot air system was used. Coated seeds were heated at 180° F. for 5 minutes or less.

After drying, the coated seed was then screened for size and can be bagged for shipment. The resulting seed's weight and size has increased, but the finished coated seed remained principally the same shape as it was prior to coating.

The total time to coat and process a batch of seed took no longer than 20 to 25 minutes.

### Example 2

### Grinding Nut Shells

This example describes methods used to crush filbert (hazelnut) shells, which are a waste-product produced by filbert producers. One skilled in the art will recognize that similar methods can be used to crush other types of nutshells (such as pecan, walnut, coconut, or macadamia shells).

Shells were fed into a tub grinder with the appropriate screen and then processed through the screens indicated for the crop of interest. For example, when the nutshells were being used with seashore paspalum ‘Sea Spray’ grass seeds, the screens used were 12/64 inch mesh.

### Example 3

### Generation of Coated Nutshell Fragments

This example describes methods used to at least partially coat the nutshell fragments produced in Example 2 with a binder and then adhere a SAP-containing composition to the seed via the binder. One skilled in the art will recognize that similar methods can be used to coat other types and sizes of nutshell fragments. For example, such methods can be used to coat coir.

PVOH was used to adhere the SAP-containing composition to the nutshells (such as Celvol® or BF17). A rate of 5 to 6 pounds of powered PVOH to 100 pounds of nutshell fragments was used. The nutshell fragments were exposed to the PVOH for 5 to 8 minutes at room temperature to obtain thorough coverage on each nutshell fragment.

The nutshell fragments that were at least partially coated with PVOH (an in some examples were completely coated with PVOH) were incubated with the SAP-containing composition, which included finely ground mineral material (plus other additives as desired, such as calcium carbonate, clay, gypsum, bentonite, and dry diatomaceous earth) and Zeba®. While the nutshell fragments coated with PVOH were being tumbled in a drum, the SAP-containing composition was applied to the nutshell fragments coated with PVOH. The amount of finely ground mineral material and Zeba® needed in the SAP-containing composition were measured beforehand, and mixed together into a single SAP-containing composition combination. This ensured that the nutshell fragments did not stick to each other and the coating was more consistent. Approximately 100 lb PVOH-coated nutshell fragments was contacted with approximately 100 lb of the SAP-containing composition. The PVOH-coated nutshell fragments were tumbled with the SAP-containing composition for about 10 to 12 minutes. This results in coated nutshell fragments (though 100% coverage by the SAP-containing composition is not required).

The surface of the coated nutshell can be colored with an agent such as a pigment or dye to identify the coated nutshell, for example using aqua blue.

The coated nutshell fragments were fed into an inclined drum to compact the coating and reduce the amount of filler material ‘flaking off’ later in transit or as the nutshell fragments are handled. The coated nutshell fragments were then immediately dried using a large fluid bed dryer or forced hot air system. Coated nutshells were heated at 180° F. for 5 minutes or less.

After drying, the coated nutshells were screened for size and can be bagged for shipment. The resulting nutshell fragments' weight and size has increased, but the finished coated nutshell fragments remain principally the same shape prior to coating.

The total time to coat and process a batch of nutshell fragments took no longer than 20 to 25 minutes.

### Example 4

### Compositions that Include Coated Seeds and Coated Nutshell Fragments

This example describes a composition that includes the coated seeds of Example 1 and the coated nutshell fragments produced in Example 3. One skilled in the art will recognize that similar methods can be used to produce similar compositions with other seeds and nutshells.

A ratio of 1:1 SAP-coated seashore paspalum seed:SAP-coated filbert nutshells were mixed. The nutshells and seed were approximately the same size ( 10/64 to 12/64 inches).

### Example 5

### Planting and Germination of Coated Seeds and Nut Shells

This example describes methods used to plant the composition described in Example 4, and the results of a comparative trial. One skilled in the art will recognize that similar methods can be used to plant and germinate similar compositions with other seeds and nutshells.

A mixture containing a ratio of 1:1 coated seashore paspalum ‘Sea Spray’ seeds to coated filbert shell fragments were seeded at a rate of 1 lb/1000 ft² (that is ½ lb of coated seed and ½ lb of coated shells per 1000 ft²) on a plot of 196 ft² in Kahului, Maui, Hawaii. A parallel plot of 196 ft² in Kahului, Maui, Hawaii was seeded with uncoated seashore paspalum ‘Sea Spray’ seeds at a rate of 1 lb uncoated seeds/1000 ft².

Previously (about 30 and 12 days prior to seeding), the plots were sprayed with RoundUp® glyphosate spray.

The mixture of coated seeds/coated nutshells or the uncoated seeds was combined with 2 gallons of compost for better distribution. The plots were raked in three directions to bury the mixture. Plots watered using sprinklers for 20 minutes, and thereafter irrigated 7-times per day at 6 am, 12 pm, 2 pm, 3 pm, 4 pm, and 5 pm for five minutes each. The day after seeding, Verdicon® fertilizer 24-6-12+10.9% S+3.1% Fe+1.0% Mg (12% polymer coated sulfur coated urea) was applied to both plots at a rate of 2 lbs/1000 ft² (741 g/196 ft²). The plots were raked in three directions to incorporate the fertilizer. Subsequently, germination and the % soil coverage was monitored in both plots (Table 1).

TABLE 1
Germination of uncoated vs. coated ‘Sea Spray’ seeds.

| | Temperature | % Soil coverage | |
|---|---|---|---|
| Date | (Min/Max) | Uncoated | Coated |
| 8/19 | 21 C./28 C. | Germination began | Germination began |
| 8/22 | 17 C./30 C. | 1-2 leaf stage | 1-2 leaf stage |
| 8/25 | 18 C./29 C. | 2-3 leaf stage | 2-3 leaf stage |
| 8/31 | 19 C./32 C. | | |
| 9/2 | 20 C./30 C. | 40% soil coverage | 30% soil coverage |
| 9/4 | 21 C./30 C. | 60% | 40% |
| 9/9 | 21 C./30 C. | 80% | 60% |
| 9/12 | 23 C./28 C. | 90% | 75% |
| 9/17 | 20 C./30 C. | 95% | 80% |
| 9/21 | 18 C./28 C. | 98% | 90% |
| 9/26 | 18 C./32 C. | 100% | 95% |
| 10/4 | 19 C./30 C. | 100% | 95% |
| 10/16 | 18 C./28 C. | 100% | 100% |

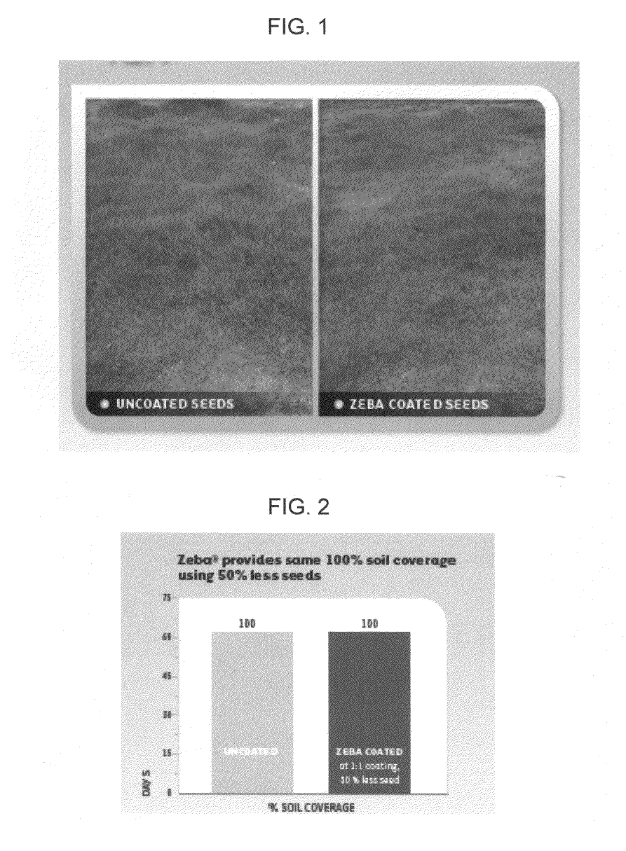

As shown in FIGS. 1 and 2, only 50% of the coated seed-coated nutshell mixture was required to provide the same 100% soil coverage obtained by non-coated seeds. Therefore, a mixture containing coated seeds and coated nutshell fragments can provide the same 100% soil coverage using 50% less seed.

### Example 6

### Generation of Coated Seeds that Include Activated Charcoal

This example describes methods used to adhere Zeba® superabsorbent polymer particles and activated charcoal to seashore paspalum ‘Sea Spray’ grass seeds. One skilled in the art will recognize that similar methods can be used to generate coated seeds from other grasses or other plants. This method is similar to that described in Example 1, except that the SAP-containing composition includes activated charcoal (ratio of 100:1 (w/w) activated charcoal: seed). One skilled in the art will recognize that the SAP-containing composition can also include coir. Furthermore, one skilled in the art will appreciate that activated charcoal or coir can be adhered before or after adhering a SAP-containing composition using similar methods.

The inventors have determined that adhering activated charcoal to seed increases the herbicide resistance of the seed, such as an increase of at least 10%, at least 25%, at least 50%, at least 75%, at least 90% or at least 99%. For example, when such seed is planted, the crop or other seed- or plant-containing area can be treated with one or more herbicides to reduce undesirable weed growth, without significantly affecting the viability of the coated seeds. This results in a crop or other treated area that is virtually weed-free (for example less than 0.05% weeds, less than 0.5% weeds, or less than 0.1% weeds). In particular examples, seeds having adhered activated charcoal have increased resistance to the following herbicides: atrazine, Karmex, diuron, and Kerb®.

Zeba® was adhered to the seed via a binder to increase the amount of moisture absorbed into the seed coating layer. With Zeba®, cracking will occur in 2 or 3 ‘block’ portions, increasing the opportunities for light and moisture penetration and thereby providing greater chance of germination. Only a relatively small amount of Zeba® is needed to provide these benefits; Zeba® was applied at a rate of 2½% to 3% of the weight of the seed.

An adhesive or binder was used to adhere the Zeba® coating to the seed, by creating a favorable moist surface for the SAP-containing composition (Zeba® powder and filler material). Because Zeba® is a superabsorbent product and absorbs water very readily, polyvinyl alcohol (PVOH) was used as the binder (Celvol® or BF17). A rate of 5 to 6 pounds of powder PVOH to 100 pounds of grass seed was used to provide a sufficiently moist surface for the SAP-containing composition to adhere. The raw seed was exposed to the PVOH binder for 5 to 8 minutes at room temperature to obtain thorough coverage on each seed piece.

The moist seeds coated with PVOH were contacted with the SAP-containing composition, which included finely ground mineral material (plus other additives as desired such as calcium carbonate, clay, gypsum, bentonite, and dry diatomaceous earth) and Zeba®. The mineral material does not substantially dissolve in water and was used to keep the moist seeds from sticking to each other.

After at least partially coating the seed with PVOH, the SAP-containing composition (finely ground filler base-mineral and additives, which may include coir), including 0.5% to 2.5% Zeba® and activated charcoal at a w/w ratio of 1:1 activated charcoal to seed) was exposed to the seed. While the seeds were being tumbled in a drum, the SAP-containing composition was applied to the seeds. The amount of finely ground mineral material, activated charcoal, and Zeba® needed were measured beforehand, and mixed together into a single SAP-containing composition. This ensured that the seeds did not stick to each other and the coating was more consistent. The seeds were tumbled with the SAP-containing composition for about 10 to 12 minutes. This resulted in a coated seed (though 100% coverage by the SAP-containing composition is not required).

The seed was fed into an inclined drum to compact the seed coating and reduce the amount of filler material ‘flaking off’ later in transit or as the seed is handled.

The coated seeds were then immediately dried before too much moisture was imbibed by the seed, causing unwanted pre-germination. A large fluid bed dryer or forced hot air system was used. Coated seeds were heated at 180° F. for 5 minutes or less.

After drying, the coated seed was then screened for size and can be bagged for shipment. The resulting seed's weight and size has increased, but the finished coated seed remained principally the same shape as it was prior to coating.

The total time to coat and process a batch of seed took no longer than 20 to 25 minutes.

### Example 7

### Coating Seeds with Charcoal, Lignosulfonate, and Diatomaceous Earth

This example describes methods used to demonstrate activated charcoal's protection qualities against herbicides, while used as a seed coating material. The coating materials included activated charcoal, diatomaceous earth, and lignosulfonate as the binding agent. One skilled in the art will appreciate that a superabsorbent polymer (e.g., Zeba®) can also be added. In addition, the coating agents can include other growth promoting material.

In the experiments below, it is shown that charcoal protects the seedling during and subsequent to herbicide applications.

### Trial #1: Formula: 92309001

Seed type: CBS II M164M-9-115, ryegrass blend
Coating material: charcoal, lignosulfonate
Ratio: 1:5.3 (seed:charcoal/lignosulfonate)
Recipe: Ryegrass seed: 16%; charcoal: 66%; lignosulfonate (LS): 19% (50% LS 50% water)

Seeds were coated with charcoal and lignosulfonate using the protocol shown in Table 2.

TABLE 2
Protocol for coating seeds with formulation 92309001

| Addition Point (Sec.) | 1 | 2 | 3 | 4 | 5 | 6 | 7 | 8 | 9 | 10 |
|---|---|---|---|---|---|---|---|---|---|---|
| Raw material | Seed (CBS II ryegrass blend) | | | | | Lignosulfonate | | | | |
| Amount (Pounds) | 5 | | | | | 0.4 | 0.4 | 0.4 | | |
| Addition Point (Sec.) | 11 | 12 | 13 | 14 | 15 | 16 | 17 | 18 | 19 | 20 |
| Raw material | Charcoal | | | | | | | | Lignosulfonate | |
| Amount | 0.4 | 0.4 | 0.4 | 0.4 | 0.4 | | | | 0.4 | 0.4 |
| Addition Point (Sec.) | 21 | 22 | 23 | 24 | 25 | 26 | 27 | 28 | 29 | 30 |
| Raw material | Lignosulfonate | | | Charcoal | | | | | | |
| Amount (Pounds) | 0.4 | | | 0.4 | 0.4 | 0.4 | 0.4 | 0.4 | 0.4 | 0.4 |
| Addition Point (Sec.) | 31 | 32 | 33 | 34 | 35 | 36 | 37 | 38 | 39 | 40 |
| Raw material | | Lignosulfonate | | | | | Charcoal | | | |
| Amount (Pounds) | | 0.4 | 0.4 | 0.4 | | | 0.4 | 0.4 | 0.4 | 0.4 |
| Addition Point (Sec.) | 41 | 42 | 43 | 44 | 45 | 46 | 47 | 48 | 49 | 50 |
| Raw material | Charcoal | | | | Lignosulfonate | | | | Charcoal | |
| Amount (Pounds) | 0.4 | 0.4 | 0.4 | | 0.4 | 0.4 | 0.4 | | 0.4 | 0.4 |
| Addition Point (Sec.) | 51 | 52 | 53 | 54 | 55 | 56 | 57 | 58 | 59 | 60 |
| Raw material | Charcoal | | | | | | | Lignosulfonate | | |
| Amount (Pounds) | 0.4 | 0.4 | 0.4 | 0.4 | 0.4 | 0.4 | | 0.4 | 0.4 | 0.4 |
| Addition Point (Sec.) | 61 | 62 | 63 | 64 | 65 | 66 | 67 | 68 | 69 | 70 |
| Raw material | | Charcoal | | | | | | | | |
| Amount (Pounds) | | 0.4 | 0.4 | 0.4 | 0.4 | 0.4 | 0.4 | 0.4 | 0.4 | |
| Addition Point (Sec.) | 71 | 72 | 73 | 74 | 75 | 76 | 77 | 78 | 79 | 80 |
| Raw material | Lignosulfonate | | | | Charcoal | | | | | |
| Amount (Pounds) | 0.4 | 0.4 | 0.4 | | 0.4 | 0.4 | 0.4 | 0.4 | 0.4 | 0.4 |
| Addition Point (Sec.) | 81 | 82 | 83 | 84 | 85 | 86 | 87 | 88 | 89 | 90 |
| Raw material | | | Lignosulfonate | | | | | Charcoal | | |
| Amount (Pounds) | | | 0.4 | 0.4 | 0.4 | | | 0.4 | 0.4 | 0.4 |
| Addition Point (Sec.) | 91 | 92 | 93 | 94 | 95 | 96 | 97 | 98 | 99 | 100 |
| Raw material | Charcoal | | | | | | Lignosulfonate | | | |
| Amount (Pounds) | 0.4 | 0.4 | 0.4 | 0.4 | | | 0.4 | 0.4 | 0.4 | |
| Addition Point (Sec.) | 101 | 102 | 103 | 104 | 105 | 106 | 107 | 108 | 109 | 110 |
| Raw material | | | Charcoal | | | | | | | Lignosulfonate |
| Amount (Pounds) | | | 0.4 | 0.4 | 0.4 | 0.4 | 0.2 | | | 0.4 |
| Addition Point (Sec.) | 111 | 112 | 113 | 114 | 115 | 116 | 117 | 118 | 119 | 120 |

| Raw material | Lignosulfonate | | | | |
|---|---|---|---|---|---|
| Amount (Pounds) | 0.4 | 0.4 | 0.4 | 0.4 | 0.4 |

| | Total Amount | Raw input % | Finished % |
|---|---|---|---|
| Seed | 5 | 13% | 16% |
| Charcoal | 21 | 55% | 66% |
| Lignosulfonate | 12 | 32% | 19% |
| Total | 38 | 100% | 100% |

The coated seed was planted as follows. Six plots were planted: five with different applications of herbicide (Karmex mixed at 63½ grams herbicide with 2 gallons of water), and 1 control plot. Two rows of charcoal-coated seed were planted approximately 2″ apart. After planting the seed was covered then sprayed the below amount of herbicide per plot:

Plot #1: Control

Plot #2: 1 pounds/acre

Plot #3: 2 pounds/acre

Plot #4: 3 pounds/acre

Plot #5: 4 pounds/acre

Plot #6: 5 pounds/acre

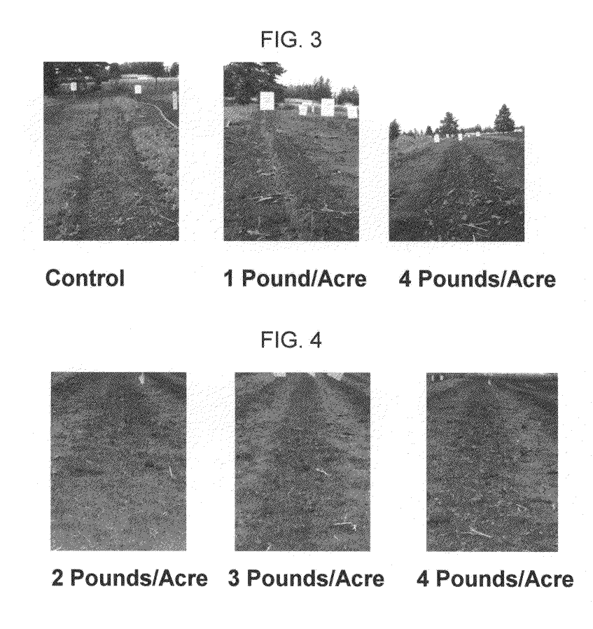

After spraying the seed, drip irrigation was placed above the planted row. Through the duration of the trial, the seeded plots remained watered to the point of color. As shown in FIG. 3, seeds coated with activated charcoal and lignosulfonate were protected from the herbicide, and resulted in a plot that had substantially fewer weeds than the plot not treated with herbicide.

### Trial #2: Formula: 92309002

Seed type: CBS II M164M-9-115, ryegrass blend
Coating material: Charcoal, Lignosulfonate
Recipe: Ryegrass seed: 16%; Charcoal: 66%; Lignosulfonate: 19% (non-diluted)

The coated seed was planted and herbicide applied as described for Trial #1. Details on the coating process are provided in Table 3. It is expected that seeds coated with activated charcoal and lignosulfonate will be protected from the herbicide.

TABLE 3
Protocol for coating seeds with formulation 92309002

| Addition Point (Sec.) | 1 | 2 | 3 | 4 | 5 | 6 | 7 | 8 | 9 | 10 |
|---|---|---|---|---|---|---|---|---|---|---|
| Raw material | Seed (CBS II ryegrass blend) | | | | | Lignosulfonate | | | | |
| Amount (Pounds) | 5 | | | | | 0.4 | 0.4 | 0.4 | | |
| Addition Point (Sec.) | 11 | 12 | 13 | 14 | 15 | 16 | 17 | 18 | 19 | 20 |
| Raw material | Charcoal | | | | | | | | Lignosulfonate | |
| Amount | 0.4 | 0.4 | 0.4 | 0.4 | 0.4 | | | | 0.4 | 0.4 |
| Addition Point (Sec.) | 21 | 22 | 23 | 24 | 25 | 26 | 27 | 28 | 29 | 30 |
| Raw material | Lignosulfonate | | | Charcoal | | | | | | |
| Amount (Pounds) | 0.4 | | | 0.4 | 0.4 | 0.4 | 0.4 | 0.4 | 0.4 | 0.4 |
| Addition Point (Sec.) | 31 | 32 | 33 | 34 | 35 | 36 | 37 | 38 | 39 | 40 |
| Raw material | | Lignosulfonate | | | | | Charcoal | | | |
| Amount (Pounds) | | 0.4 | 0.4 | 0.4 | | | 0.4 | 0.4 | 0.4 | 0.4 |
| Addition Point (Sec.) | 41 | 42 | 43 | 44 | 45 | 46 | 47 | 48 | 49 | 50 |
| Raw material | Charcoal | | | | Lignosulfonate | | | | Charcoal | |
| Amount (Pounds) | 0.4 | 0.4 | 0.4 | | 0.4 | 0.4 | 0.4 | | 0.4 | 0.4 |
| Addition Point (Sec.) | 51 | 52 | 53 | 54 | 55 | 56 | 57 | 58 | 59 | 60 |
| Raw material | Charcoal | | | | | | | Lignosulfonate | | |
| Amount (Pounds) | 0.4 | 0.4 | 0.4 | 0.4 | 0.4 | 0.4 | | 0.4 | 0.4 | 0.4 |
| Addition Point (Sec.) | 61 | 62 | 63 | 64 | 65 | 66 | 67 | 68 | 69 | 70 |
| Raw material | | Charcoal | | | | | | | | |
| Amount (Pounds) | | 0.4 | 0.4 | 0.4 | 0.4 | 0.4 | 0.4 | 0.4 | 0.4 | |
| Addition Point (Sec.) | 71 | 72 | 73 | 74 | 75 | 76 | 77 | 78 | 79 | 80 |
| Raw material | Lignosulfonate | | | | Charcoal | | | | | |
| Amount (Pounds) | 0.4 | 0.4 | 0.4 | | 0.4 | 0.4 | 0.4 | 0.4 | 0.4 | 0.4 |
| Addition Point (Sec.) | 81 | 82 | 83 | 84 | 85 | 86 | 87 | 88 | 89 | 90 |
| Raw material | | | Lignosulfonate | | | | | Charcoal | | |
| Amount (Pounds) | | | 0.4 | 0.4 | 0.4 | | | 0.4 | 0.4 | 0.4 |
| Addition Point (Sec.) | 91 | 92 | 93 | 94 | 95 | 96 | 97 | 98 | 99 | 100 |
| Raw material | Charcoal | | | | | | Lignosulfonate | | | |
| Amount (Pounds) | 0.4 | 0.4 | 0.4 | 0.4 | | | 0.4 | 0.4 | 0.4 | |
| Addition Point (Sec.) | 101 | 102 | 103 | 104 | 105 | 106 | 107 | 108 | 109 | 110 |
| Raw material | | | Charcoal | | | | | | | Lignosulfonate |
| Amount (Pounds) | | | 0.4 | 0.4 | 0.4 | 0.4 | 0.2 | | | 0.4 |
| Addition Point (Sec.) | 111 | 112 | 113 | 114 | 115 | 116 | 117 | 118 | 119 | 120 |

| Raw material | Lignosulfonate | | | | |
|---|---|---|---|---|---|
| Amount (Pounds) | 0.4 | 0.4 | 0.4 | 0.4 | 0.4 |

| | Total Amount | Raw input % | Finished % |
|---|---|---|---|
| Seed | 5 | 13% | 16% |
| Charcoal | 21 | 55% | 66% |
| Lignosulfonate | 12 | 32% | 19% |
| Total | 38 | 100% | 100% |

### Trial #3: Formula: 101709003

Seed type: CBS II M164M-9-115, ryegrass blend
Coating material: charcoal, lignosulfonate, diatomaceous earth
Ratio: 1:4 seed to buildup (charcoal, lignosulfonate, diatomaceous earth)
Recipe: Ryegrass seed: 25%; charcoal: 25%; lignosulfonate: 25% (non-diluted); diatomaceous earth: 25%

The coated seed was prepared as shown in Table 4, then planted as follows. Six plots were planted: five with different applications of herbicide (Karmex; 36.3 grams herbicide with 2 gallons of water), and 1 control plot. One row of charcoal coated seed was planted approximately 2″ apart. After planting the seed was covered then sprayed the below amount of herbicide per plot:
Plot #1: Control
Plot #2: 2 pounds/acre
Plot #3: 3 pounds/acre
Plot #4: 4 pounds/acre
Plot #5: 5 pounds/acre
Plot #6: 6 pounds/acre

After spraying the seed, drip irrigation was placed above the planted row. Through the duration of the trial, the seeded plots remained watered to the point of color. As shown in FIG. 4, seeds coated with activated charcoal, lignosulfonate and diatomaceous earth were protected from the herbicide, even with large quantities of herbicide.

TABLE 4
Protocol for coating seeds with formulation 101709003

| Addition Point (Sec.) | 1 | 2 | 3 | 4 | 5 | 6 | 7 | 8 | 9 | 10 |
|---|---|---|---|---|---|---|---|---|---|---|
| Raw material | Seed (CBS II ryegrass blend) | | | | | Lignosulfonate | | | | |
| Amount (Pounds) | 5 | | | | | 0.3 | 0.3 | 0.3 | | |
| Addition Point (Sec.) | 11 | 12 | 13 | 14 | 15 | 16 | 17 | 18 | 19 | 20 |
| Raw material | charcoal/D.E. | | | | | | | | Lignosulfonate | |
| Amount | 0.2 | 0.2 | 0.2 | 0.2 | 0.2 | | | | 0.4 | 0.4 |
| Addition Point (Sec.) | 21 | 22 | 23 | 24 | 25 | 26 | 27 | 28 | 29 | 30 |
| Raw material | Lignosulfonate | | | charcoal/D.E. | | | | | | |
| Amount (Pounds) | 0.4 | | | 0.2 | 0.2 | 0.2 | 0.2 | 0.2 | 0.2 | 0.2 |
| Addition Point (Sec.) | 31 | 32 | 33 | 34 | 35 | 36 | 37 | 38 | 39 | 40 |
| Raw material | | Lignosulfonate | | | | | charcoal/D.E. | | | |
| Amount (Pounds) | | 0.4 | 0.4 | 0.4 | | | 0.2 | 0.2 | 0.2 | 0.2 |
| Addition Point (Sec.) | 41 | 42 | 43 | 44 | 45 | 46 | 47 | 48 | 49 | 50 |
| Raw material | charcoal/D.E. | | | | Lignosulfonate | | | | charcoal/D.E. | |
| Amount (Pounds) | 0.2 | 0.2 | 0.2 | | 0.4 | 0.4 | 0.3 | | 0.2 | 0.2 |
| Addition Point (Sec.) | 51 | 52 | 53 | 54 | 55 | 56 | 57 | 58 | 59 | 60 |
| Raw material | charcoal/D.E. | | | | | | | Lignosulfonate | | |
| Amount (Pounds) | 0.2 | 0.2 | 0.2 | 0.2 | 0.2 | 0.2 | | 0.3 | 0.3 | 0.3 |
| Addition Point (Sec.) | 61 | 62 | 63 | 64 | 65 | 66 | 67 | 68 | 69 | 70 |
| Raw material | | charcoal/D.E. | | | | | | | | |
| Amount (Pounds) | | 0.2 | 0.2 | 0.2 | 0.2 | 0.2 | 0.2 | 0.2 | 0.2 | |
| Addition Point (Sec.) | 71 | 72 | 73 | 74 | 75 | 76 | 77 | 78 | 79 | 80 |
| Raw material | Lignosulfonate | | | | charcoal/D.E. | | | | | |
| Amount (Pounds) | 0.3 | 0.3 | 0.3 | | 0.2 | 0.2 | 0.2 | 0.2 | 0.2 | 0.2 |
| Addition Point (Sec.) | 81 | 82 | 83 | 84 | 85 | 86 | 87 | 88 | 89 | 90 |
| Raw material | | | Lignosulfonate | | | | | charcoal/D.E. | | |
| Amount (Pounds) | | | 0.3 | 0.3 | 0.3 | | | 0.2 | 0.2 | 0.2 |
| Addition Point (Sec.) | 91 | 92 | 93 | 94 | 95 | 96 | 97 | 98 | 99 | 100 |
| Raw material | charcoal/D.E. | | | | | | Lignosulfonate | | | |
| Amount (Pounds) | 0.2 | 0.2 | 0.2 | 0.1 | | | 0.3 | 0.3 | 0.3 | |
| Addition Point (Sec.) | 101 | 102 | 103 | 104 | 105 | 106 | 107 | 108 | 109 | 110 |
| Raw material | | | charcoal/D.E. | | | | | | | Lignosulfonate |
| Amount (Pounds) | | | 0.1 | 0.1 | 0.1 | 0.1 | 0.1 | | | 0.3 |
| Addition Point (Sec.) | 111 | 112 | 113 | 114 | 115 | 116 | 117 | 118 | 119 | 120 |

| Raw material | Lignosulfonate | | | | |
|---|---|---|---|---|---|
| Amount (Pounds) | 0.3 | 0.3 | 0.3 | 0.3 | 0.3 |

| | Total Amount | Raw input % | Finished % |
|---|---|---|---|
| Seed | 5 | 20% | 25% |
| charcoal/D.E. | 10 | 40% | 50% |
| Lignosulfonate | 9.8 | 40% | 25% |
| Total | 24.8 | 100% | 100% |

### Trial #4: Formula: 92309004

Seed type: CBS II M164M-9-115, ryegrass blend
Coating material: Charcoal, Lignosulfonate, Diatomaceous Earth
Ratio: 1:5 seed to buildup (charcoal, lignosulfonate, diatomaceous earth)
Recipe: Ryegrass seed: 20%; Charcoal: 29%; Lignosulfonate: 29% (non-diluted);

### Diatomaceous Earth: 29%

The coated seed was prepared as shown in Table 5, and planted and herbicide applied as described for Trial #3. It is expected that seeds coated with activated charcoal, diatomaceous earth and lignosulfonate will be protected from the herbicide.

TABLE 5
Protocol for coating seeds with formulation 92309004

| Addition Point (Sec.) | 1 | 2 | 3 | 4 | 5 | 6 | 7 | 8 | 9 | 10 |
|---|---|---|---|---|---|---|---|---|---|---|
| Raw material | Seed (CBS II ryegrass blend) | | | | | Lignosulfonate | | | | |
| Amount (Pounds) | 5 | | | | | 0.5 | 0.5 | 0.5 | | |
| Addition Point (Sec.) | 11 | 12 | 13 | 14 | 15 | 16 | 17 | 18 | 19 | 20 |
| Raw material | charcoal/D.E. | | | | | | | | Lignosulfonate | |
| Amount | 0.3 | 0.3 | 0.3 | 0.3 | 0.3 | | | | 0.4 | 0.4 |
| Addition Point (Sec.) | 21 | 22 | 23 | 24 | 25 | 26 | 27 | 28 | 29 | 30 |
| Raw material | Lignosulfonate | | | charcoal/D.E. | | | | | | |
| Amount (Pounds) | 0.4 | | | 0.3 | 0.3 | 0.3 | 0.3 | 0.3 | 0.3 | 0.3 |
| Addition Point (Sec.) | 31 | 32 | 33 | 34 | 35 | 36 | 37 | 38 | 39 | 40 |
| Raw material | | Lignosulfonate | | | | | charcoal/D.E. | | | |
| Amount (Pounds) | | 0.4 | 0.4 | 0.4 | | | 0.3 | 0.3 | 0.3 | 0.3 |
| Addition Point (Sec.) | 41 | 42 | 43 | 44 | 45 | 46 | 47 | 48 | 49 | 50 |
| Raw material | charcoal/D.E. | | | | Lignosulfonate | | | | charcoal/D.E. | |
| Amount (Pounds) | 0.3 | 0.3 | 0.3 | | 0.4 | 0.4 | 0.4 | | 0.3 | 0.3 |
| Addition Point (Sec.) | 51 | 52 | 53 | 54 | 55 | 56 | 57 | 58 | 59 | 60 |
| Raw material | charcoal/D.E. | | | | | | | Lignosulfonate | | |
| Amount (Pounds) | 0.3 | 0.3 | 0.3 | 0.3 | 0.3 | 0.3 | | 0.4 | 0.4 | 0.4 |
| Addition Point (Sec.) | 61 | 62 | 63 | 64 | 65 | 66 | 67 | 68 | 69 | 70 |
| Raw material | | charcoal/D.E. | | | | | | | | |
| Amount (Pounds) | | 0.3 | 0.3 | 0.3 | 0.3 | 0.3 | 0.3 | 0.3 | 0.3 | |
| Addition Point (Sec.) | 71 | 72 | 73 | 74 | 75 | 76 | 77 | 78 | 79 | 80 |
| Raw material | Lignosulfonate | | | | charcoal/D.E. | | | | | |
| Amount (Pounds) | 0.4 | 0.4 | 0.4 | | 0.3 | 0.3 | 0.3 | 0.3 | 0.3 | 0.3 |
| Addition Point (Sec.) | 81 | 82 | 83 | 84 | 85 | 86 | 87 | 88 | 89 | 90 |
| Raw material | | | Lignosulfonate | | | | | charcoal/D.E. | | |
| Amount (Pounds) | | | 0.4 | 0.4 | 0.4 | | | 0.3 | 0.3 | 0.3 |
| Addition Point (Sec.) | 91 | 92 | 93 | 94 | 95 | 96 | 97 | 98 | 99 | 100 |
| Raw material | charcoal/D.E. | | | | | | Lignosulfonate | | | |
| Amount (Pounds) | 0.3 | 0.3 | 0.3 | 0.15 | | | 0.4 | 0.4 | 0.4 | |
| Addition Point (Sec.) | 101 | 102 | 103 | 104 | 105 | 106 | 107 | 108 | 109 | 110 |
| Raw material | | | charcoal/D.E. | | | | | | | Lignosulfonate |
| Amount (Pounds) | | | 0.15 | 0.15 | 0.15 | 0.15 | 0.15 | | | 0.4 |
| Addition Point (Sec.) | 111 | 112 | 113 | 114 | 115 | 116 | 117 | 118 | 119 | 120 |

| Raw material | Lignosulfonate | | | | |
|---|---|---|---|---|---|
| Amount (Pounds) | 0.4 | 0.4 | 0.4 | 0.4 | 0.4 |

| | Total Amount | Raw input % | Finished % |
|---|---|---|---|
| Seed | 5 | 15% | 19% |
| charcoal/D.E. | 15 | 46% | 57% |
| Lignosulfonate | 12.3 | 38% | 24% |
| Total | 32.3 | 100% | 100% |

### Trial #5: Formula: 92309005

Seed type: CBS II M164M-9-115, ryegrass blend
Coating material: Charcoal, Lignosulfonate, Diatomaceous Earth
Ratio: 1:6 seed to buildup (charcoal, lignosulfonate, diatomaceous earth)
Recipe: Ryegrass seed: 15%; charcoal: 30%; Lignosulfonate: 30% (non-diluted); diatomaceous earth: 25%

The coated seed was prepared as shown in Table 6, then planted and herbicide applied as described for Trial #3, except that two rows were planted. It is expected that seeds coated with activated charcoal, diatomaceous earth and lignosulfonate will be protected from the herbicide.

TABLE 6
Protocol for coating seeds with formulation 92309005

| Addition Point (Sec.) | 1 | 2 | 3 | 4 | 5 | 6 | 7 | 8 | 9 | 10 |
|---|---|---|---|---|---|---|---|---|---|---|
| Raw material | Seed (CBS II ryegrass blend) | | | | | Lignosulfonate | | | | |
| Amount (Pounds) | 5 | | | | | 0.6 | 0.6 | 0.6 | | |
| Addition Point (Sec.) | 11 | 12 | 13 | 14 | 15 | 16 | 17 | 18 | 19 | 20 |
| Raw material | charcoal/D.E. | | | | | | | | Lignosulfonate | |
| Amount | 0.4 | 0.4 | 0.4 | 0.4 | 0.4 | | | | 0.5 | 0.5 |
| Addition Point (Sec.) | 21 | 22 | 23 | 24 | 25 | 26 | 27 | 28 | 29 | 30 |
| Raw material | Lignosulfonate | | | charcoal/D.E. | | | | | | |
| Amount (Pounds) | 0.5 | | | 0.4 | 0.4 | 0.4 | 0.4 | 0.4 | 0.4 | 0.4 |
| Addition Point (Sec.) | 31 | 32 | 33 | 34 | 35 | 36 | 37 | 38 | 39 | 40 |
| Raw material | | Lignosulfonate | | | | | charcoal/D.E. | | | |
| Amount (Pounds) | | 0.5 | 0.5 | 0.5 | | | 0.4 | 0.4 | 0.4 | 0.4 |
| Addition Point (Sec.) | 41 | 42 | 43 | 44 | 45 | 46 | 47 | 48 | 49 | 50 |
| Raw material | charcoal/D.E. | | | | Lignosulfonate | | | | charcoal/D.E. | |
| Amount (Pounds) | 0.4 | 0.4 | 0.4 | | 0.5 | 0.5 | 0.5 | | 0.4 | 0.4 |
| Addition Point (Sec.) | 51 | 52 | 53 | 54 | 55 | 56 | 57 | 58 | 59 | 60 |
| Raw material | charcoal/D.E. | | | | | | | Lignosulfonate | | |
| Amount (Pounds) | 0.4 | 0.4 | 0.4 | 0.4 | 0.4 | 0.4 | | 0.5 | 0.5 | 0.5 |
| Addition Point (Sec.) | 61 | 62 | 63 | 64 | 65 | 66 | 67 | 68 | 69 | 70 |
| Raw material | | charcoal/D.E. | | | | | | | | |
| Amount (Pounds) | | 0.4 | 0.4 | 0.4 | 0.4 | 0.4 | 0.4 | 0.4 | 0.4 | |
| Addition Point (Sec.) | 71 | 72 | 73 | 74 | 75 | 76 | 77 | 78 | 79 | 80 |
| Raw material | Lignosulfonate | | | | charcoal/D.E. | | | | | |
| Amount (Pounds) | 0.5 | 0.5 | 0.5 | | 0.4 | 0.4 | 0.4 | 0.4 | 0.4 | 0.4 |
| Addition Point (Sec.) | 81 | 82 | 83 | 84 | 85 | 86 | 87 | 88 | 89 | 90 |
| Raw material | | | Lignosulfonate | | | | | charcoal/D.E. | | |
| Amount (Pounds) | | | 0.5 | 0.5 | 0.5 | | | 0.4 | 0.4 | 0.4 |
| Addition Point (Sec.) | 91 | 92 | 93 | 94 | 95 | 96 | 97 | 98 | 99 | 100 |
| Raw material | charcoal/D.E. | | | | | | Lignosulfonate | | | |
| Amount (Pounds) | 0.4 | 0.4 | 0.4 | 0.2 | | | 0.5 | 0.5 | 0.5 | |
| Addition Point (Sec.) | 101 | 102 | 103 | 104 | 105 | 106 | 107 | 108 | 109 | 110 |
| Raw material | | | charcoal/D.E. | | | | | | | Lignosulfonate |
| Amount (Pounds) | | | 0.2 | 0.2 | 0.2 | 0.2 | 0.2 | | | 0.5 |
| Addition Point (Sec.) | 111 | 112 | 113 | 114 | 115 | 116 | 117 | 118 | 119 | 120 |

| Raw material | Lignosulfonate | | | | |
|---|---|---|---|---|---|
| Amount (Pounds) | 0.4 | 0.4 | 0.4 | 0.4 | 0.4 |

| | Total Amount | Raw input % | Finished % |
|---|---|---|---|
| Seed | 5 | 13% | 15% |
| charcoal/D.E. | 20 | 50% | 62% |
| Lignosulfonate | 14.8 | 37% | 23% |
| Total | 39.8 | 100% | 100% |

In summary, applying a coating containing charcoal to seeds permits the application of herbicides to a field planted with the coated seeds, while negating the necessity of applying charcoal over the planted seed rows. The binder used, such as lignosulfonate, ideally creates adhesion but is not too viscous where solubility is compromised. Exemplary ratios of seed to the coating (which can include charcoal, lignosulfonate, diatomaceous earth, and optionally SAP particles and other materials), include about at least 1:2; 1:4; 1:5, and 1:6. In a specific example, the ratio of seed to the coating (which can include charcoal, lignosulfonate, diatomaceous earth, and optionally SAP particles and other materials) is at least 1:6.

Based on the results from these trials, one skilled in the art will appreciate that these methods and compositions have a broad application to produce many crops. For example, it can be used where use of herbicides is desired, where the herbicide is one that can be neutralized by charcoal. Activated charcoal neutralizes most commonly used herbicides, while providing near perfect weed control. This invention will eliminate the present day technique of applying bands of charcoal over planted rows.

In view of the many possible embodiments to which the principles of the disclosure may be applied, it should be recognized that the illustrated embodiments are only examples of the disclosure and should not be taken as limiting the scope of the disclosure. Rather, the scope of the disclosure is defined by the following claims. We therefore claim as our invention all that comes within the scope and spirit of these claims.

We claim:

1. A seed-coating composition, comprising:
activated charcoal and lignosulfonate.

2. The composition of claim 1, wherein the coating composition further comprises diatomaceous earth.

3. The composition of claim 1, wherein the coating composition further comprises super-absorbent polymer (SAP) particles.

4. The composition of claim 1, wherein the ratio of the activated charcoal to the lignosulfonate is about 1:1 by weight.

5. The composition of claim 2, wherein the ratio of the activated charcoal to the lignosulfonate to the diatomaceous earth is about 1:1:1 by weight.

6. The composition of claim 3, wherein the SAP comprises about 0.5 to 5% of the coating composition.

7. The composition of claim 1, further comprising:
seeds coated at least partially with the lignosulfonate; and
charcoal adhered to the seeds by the lignosulfonate.

8. The composition of claim 2, further comprising:
seeds coated at least partially with the lignosulfonate; and
activated charcoal and diatomaceous earth adhered to the seeds by the lignosulfonate.

9. The composition of claim 7, wherein the seed to lignosulfonate, activated charcoal, diatomaceous earth ratio is at least 1:4 or at least 1:6 by weight.

10. A composition comprising;
seeds at least partially coated with a binder;
activated charcoal and diatomaceous earth adhered to the seeds by the binder.

11. The composition of claim 10, wherein ratio of the seeds to the binder, activated charcoal and diatomaceous earth is at least 1:6 by weight.

12. A method of making charcoal-coated seeds, comprising:
coating seeds at least partially with a binder, thereby generating binder-coated seeds;
adhering a coating composition comprising activated charcoal to the coated seed, thereby generating charcoal-coated seeds.

13. The method of claim 12, further comprising coating the charcoal-coated seeds with the binder, thereby generating re-binder coated seeds, and subsequently adhering the coating composition to the re-binder coated seeds.

14. The method of claim 12, further comprising adhering SAP particles to the binder-coated seeds or the charcoal-coated seeds.

15. The method of claim 12, further comprising planting the charcoal-coated seeds, thereby permitting germination of the seeds.

16. The method of claim 15, further comprising applying herbicide to the planted seeds, wherein the method does not comprise placing activated charcoal over the planted seeds prior to applying the herbicide.

17. The method of claim 12, wherein the coating composition further comprises diatomaceous earth.

18. The method of claim 14, wherein the SAP particles are adhered to the binder-coated seed or the charcoal-coated seed at a rate of 1% to 5% of the weight of the seed.

19. A seed, comprising:
seed at least partially coated with a binder; and
a coating composition comprising activated charcoal adhered to the seed by the binder.

20. The seed of claim 19, wherein the composition comprising activated charcoal further comprises diatomaceous earth, SAP particles, or combinations thereof.
